(19) United States
(12) Patent Application Publication
(10) Pub. No.: US 2009/0135753 A1
(43) Pub. Date: May 28, 2009

(54) POWER-CONSERVING NETWORK DEVICE FOR ADVANCED METERING INFRASTRUCTURE

(76) Inventor: Michel VEILLETTE, Waterloo (CA)

Correspondence Address: King and Spalding LLP (Trilliant);Trilliant Customer Number, 1700 Pennsylvania Avenue, NW, Suite 200, Washington, DC, 20006, US

(21) Appl. No.: 12/275,251

(22) Filed: Nov. 21, 2008

Related U.S. Application Data
(60) Provisional application No. 60/989,957, filed on Nov. 25, 2007.
(60) Provisional application No. 60/989,967, filed on Nov. 25, 2007.
(60) Provisional application No. 60/989,958, filed on Nov. 25, 2007.
(60) Provisional application No. 60/989,964, filed on Nov. 25, 2007.
(60) Provisional application No. 60/989,950, filed on Nov. 25, 2007.
(60) Provisional application No. 60/989,953, filed on Nov. 25, 2007.
(60) Provisional application No. 60/989,975, filed on Nov. 25, 2007.
(60) Provisional application No. 60/989,959, filed on Nov. 25, 2007.
(60) Provisional application No. 60/989,960, filed on Nov. 25, 2007.
(60) Provisional application No. 60/989,961, filed on Nov. 25, 2007.
(60) Provisional application No. 60/989,962, filed on Nov. 25, 2007.
(60) Provisional application No. 60/989,951, filed on Nov. 25, 2007.
(60) Provisional application No. 60/989,955, filed on Nov. 25, 2007.
(60) Provisional application No. 60/989,952, filed on Nov. 25, 2007.
(60) Provisional application No. 60/989,954, filed on Nov. 25, 2007.
(60) Provisional application No. 60/992,312, filed on Dec. 4, 2007.
(60) Provisional application No. 60/992,313, filed on Dec. 4, 2007.
(60) Provisional application No. 60/992,315, filed on Dec. 4, 2007.
(60) Provisional application No. 61/025,279, filed on Jan. 31, 2008.
(60) Provisional application No. 61/025,270, filed on Jan. 31, 2008.
(60) Provisional application No. 61/025,276, filed on Jan. 31, 2008.
(60) Provisional application No. 61/025,282, filed on Jan. 31, 2008.
(60) Provisional application No. 61/025,284, filed on Jan. 31, 2008.
(60) Provisional application No. 61/025,271, filed on Jan. 31, 2008.
(60) Provisional application No. 61/025,287, filed on Jan. 31, 2008.
(60) Provisional application No. 61/025,278, filed on Jan. 31, 2008.
(60) Provisional application No. 61/025,273, filed on Jan. 31, 2008.
(60) Provisional application No. 61/025,277, filed on Jan. 31, 2008.
(60) Provisional application No. 61/094,116, filed on Sep. 4, 2008.

(51) Int. Cl. G08C 17/00

(52) U.S. Cl. 370/311

(57) ABSTRACT

A method and system may provide supporting reduced functionality devices in an AMI system. The method may include receiving at least one transmission from at least one candidate router, the transmission including candidate router information. The method may include selecting a router from the at least one candidate router. The method may include associating with a mesh gate by sending a device identifier to the mesh gate via the selected router. The method may include initiating a sleep cycle. The method may include receiving a held message from the router after waking up from the sleep cycle, wherein the held message is received by the router during the sleep cycle.

### CROSS REFERENCE TO RELATED APPLICATIONS

This application claims the benefit of priority to the following United States provisional patent applications which are incorporated herein by reference in their entirety:

Ser. No. 60/989,957 entitled “Point-to-Point Communication within a Mesh Network”, filed Nov. 25, 2007 (Attorney Docket No. TR0004-PRO);

Ser. No. 60/989,967 entitled “Efficient And Compact Transport Layer And Model For An Advanced Metering Infrastructure (AMI) Network,” filed Nov. 25, 2007 (Attorney Docket No. TR0003-PRO);

Ser. No. 60/989,958 entitled “Creating And Managing A Mesh Network Including Network Association,” filed Nov. 25, 2007 (Attorney Docket No. TR0005-PRO);

Ser. No. 60/989,964 entitled “Route Optimization Within A Mesh Network,” filed Nov. 25, 2007 (Attorney Docket No. TR0007-PRO);

Ser. No. 60/989,950 entitled “Application Layer Device Agnostic Collector Utilizing ANSI C12.22,” filed Nov. 25, 2007 (Attorney Docket No. TR0009-PRO);

Ser. No. 60/989,953 entitled “System And Method For Real Time Event Report Generation Between Nodes And Head End Server In A Meter Reading Network Including From Smart And Dumb Meters,” filed Nov. 25, 2007 (Attorney Docket No. TR0010-PRO);

Ser. No. 60/989,975 entitled “System and Method for Network (Mesh) Layer And Application Layer Architecture And Processes,” filed Nov. 25, 2007 (Attorney Docket No. TR0014-PRO);

Ser. No. 60/989,959 entitled “Tree Routing Within a Mesh Network,” filed Nov. 25, 2007 (Attorney Docket No. TR0017-PRO);

Ser. No. 60/989,960 entitled “Reduced Functionality Devices Within a Mesh Network” filed Nov. 25, 2007 (Attorney Docket No. TR0018-PRO);

Ser. No. 60/989,961 entitled “Source Routing Within a Mesh Network,” filed Nov. 25, 2007 (Attorney Docket No. TR0019-PRO);

Ser. No. 60/989,962 entitled “Creating and Managing a Mesh Network,” filed Nov. 25, 2007 (Attorney Docket No. TR0020-PRO);

Ser. No. 60/989,951 entitled “Network Node And Collector Architecture For Communicating Data And Method Of Communications,” filed Nov. 25, 2007 (Attorney Docket No. TR0021-PRO);

Ser. No. 60/989,955 entitled “System And Method For Recovering From Head End Data Loss And Data Collector Failure In An Automated Meter Reading Infrastructure,” filed Nov. 25, 2007 (Attorney Docket No. TR0022-PRO);

Ser. No. 60/989,952 entitled “System And Method For Assigning Checkpoints To A Plurality Of Network Nodes In Communication With A Device Agnostic Data Collector,” filed Nov. 25, 2007 (Attorney Docket No. TR0023-PRO);

Ser. No. 60/989,954 entitled “System And Method For Synchronizing Data In An Automated Meter Reading Infrastructure,” filed Nov. 25, 2007 (Attorney Docket No. TR0024-PRO);

Ser. No. 60/992,312 entitled “Mesh Network Broadcast,” filed Dec. 4, 2007 (Attorney Docket No. TR0027-PRO);

Ser. No. 60/992,313 entitled “Multi Tree Mesh Networks”, filed Dec. 4, 2007 (Attorney Docket No. TR0028-PRO);

Ser. No. 60/992,315 entitled “Mesh Routing Within a Mesh Network,” filed Dec. 4, 2007 (Attorney Docket No. TR0029-PRO);

Ser. No. 61/025,279 entitled “Point-to-Point Communication within a Mesh Network”, filed Jan. 31, 2008 (Attorney Docket No. TR0030-PRO).

Ser. No. 61/025,270 entitled “Application Layer Device Agnostic Collector Utilizing Standardized Utility Metering Protocol Such As ANSI C12.22,” filed Jan. 31, 2008 (Attorney Docket No. TR0031-PRO);

Ser. No. 61/025,276 entitled “System And Method For Real-Time Event Report Generation Between Nodes And Head End Server In A Meter Reading Network Including Form Smart And Dumb Meters,” filed Jan. 31, 2008 (Attorney Docket No. TR0032-PRO);

Ser. No. 61/025,282 entitled “Method And System for Creating And Managing Association And Balancing Of A Mesh Device In A Mesh Network,” filed Jan. 31, 2008 (Attorney Docket No. TR0035-PRO);

Ser. No. 61/025,284 entitled “Reduced Functionality Devices Within a Mesh Network,” filed Jan. 31, 2008 (Attorney Docket No. TR0036-PRO);

Ser. No. 61/025,271 entitled “Method And System for Creating And Managing Association And Balancing Of A Mesh Device In A Mesh Network,” filed Jan. 31, 2008 (Attorney Docket No. TR0037-PRO);

Ser. No. 61/025,287 entitled “System And Method For Operating Mesh Devices In Multi-Tree Overlapping Mesh Networks”, filed Jan. 31, 2008 (Attorney Docket No. TR0038-PRO);

Ser. No. 61/025,278 entitled “System And Method For Recovering From Head End Data Loss And Data Collector Failure In An Automated Meter Reading Infrastructure,” filed Jan. 31, 2008 (Attorney Docket No. TR0039-PRO);

Ser. No. 61/025,273 entitled “System And Method For Assigning Checkpoints to A Plurality Of Network Nodes In Communication With A Device-Agnostic Data Collector,” filed Jan. 31, 2008 (Attorney Docket No. TR0040-PRO);

Ser. No. 61/025,277 entitled “System And Method For Synchronizing Data In An Automated Meter Reading Infrastructure,” filed Jan. 31, 2008 (Attorney Docket No. TR0041-PRO);

Ser. No. 61/094,116 entitled “Message Formats and Processes for Communication Across a Mesh Network,” filed Sep. 4, 2008 (Attorney Docket No. TR0049-PRO).

This application hereby references and incorporates by reference each of the following United States patent applications filed contemporaneously herewith:

Ser. No. ______ entitled “Point-to-Point Communication within a Mesh Network”, filed Nov. 21, 2008 (Attorney Docket No. TR0004-US);

Ser. No. ______ entitled “Efficient And Compact Transport Layer And Model For An Advanced Metering Infrastructure (AMI) Network,” filed Nov. 21, 2008 (Attorney Docket No. TR0003-US);

Ser. No. ______ entitled “Communication and Message Route Optimization and Messaging in a Mesh Network,” filed Nov. 21, 2008 (Attorney Docket No. TR0007-US);

Ser. No. ______ entitled “Collector Device and System Utilizing Standardized Utility Metering Protocol,” filed Nov. 21, 2008 (Attorney Docket No. TR0009-US);

Ser. No. ______ entitled “Method and System for Creating and Managing Association and Balancing of a Mesh Device in a Mesh Network,” filed Nov. 21, 2008 (Attorney Docket No. TR0020-US); and

Ser. No. ______ entitled “System And Method For Operating Mesh Devices In Multi-Tree Overlapping Mesh Networks”, filed Nov. 21, 2008 (Attorney Docket No. TR0038-US).

### FIELD OF THE INVENTION

This invention pertains generally to methods, devices and systems for providing and using reduced functionality network devices (RFNDs) also referred to as power conserving network devices (PCNDs) within a mesh network and more particularly to RFNDs that may be functional mesh devices that enter low-power consumption modes or cycles such as periodic sleep cycles to conserve battery power or other storage energy resources.

### BACKGROUND

A mesh network is a wireless network configured to route data between mesh device nodes within the network. It allows for continuous connections and reconfigurations around broken or blocked paths by retransmitting messages from node to node until a destination is reached. Mesh networks differ from other networks in that nodes can all connect to each other via multiple hops. Thus, mesh networks are self-healing: the network remains operational when a node or a connection fails.

Advanced Metering Infrastructure (AMI) or Advanced Metering Management (AMM) are systems that measure, collect and analyze utility usage, from advanced devices such as electricity meters, gas meters, and water meters, through a network on request or a pre-defined schedule. This infrastructure includes hardware, software, communications, customer associated systems and meter data management software. The infrastructure collects and distributes information to customers, suppliers, utility companies and service providers. This enables these businesses to either participate in, or provide, demand response solutions, products and services. Customers may alter energy usage patterns from normal consumption patterns in response to demand pricing. This improves system load and reliability.

Heretofore, such AMI and AMM systems have limited the number of network devices, the operational capabilities of network devices, or both. Such limitations are at least in part because of the energy consumed by such devices. This has been especially true for devices that do not have a continuous connection to an energy supply either for operation or recharging of an on-board energy storage system. In addition, a maximum number of network devices that can be effectively managed can be limited by the resources of the infrastructure.

### SUMMARY

Reduced Functionality Network Devices (RFNDs), also referred to as Power Conserving Network Devices (PCNDs), within a mesh network provide functionality similar to mesh devices, but enter periodic sleep cycles to conserve power. Thus, the RFND does not participate in the mesh network as a regular mesh device by forwarding messages between other mesh devices.

Instead, the RFND or PCND utilizes a router to communicate with the mesh network. The RFND selects a neighboring mesh device as a router. The router forwards messages between the RFND and the mesh network. The router can also store responses from the mesh network to the RFND, for example, when the RFND is asleep. The RFND can retrieve stored responses from the router when the RFND wakes from a sleep or other energy or power conserving cycle. By utilizing a router, the RFND is able to access to all services over the mesh network.

In one aspect, there is provided a method for accessing access point services by a power-conserving network device, including: receiving at least one transmission from at least one candidate router, the transmission including candidate router information; selecting a particular router from the at least one candidate router; associating with an access point by transmitting a device identifier to the access point via the selected particular router; transmitting a request for an access point service; initiating an energy conserving cycle; and retrieving a held message from the particular router after automatically waking up from the energy conserving cycle, wherein the held message is received by the particular router during the energy conserving cycle responsive to the request for the access point service.

In another aspect, there is provided a method, including: associating with a mesh network, the mesh network in communication with at least one mesh device; transmitting a router information to a reduced functionality device; receiving a device identifier from the reduced functionality device indicating a request for router services; forwarding communications from the reduced functionality device to a mesh device on the mesh network; responsive to receiving a message addressed to the reduced functionality device, holding the received message if the reduced functionality device is in a sleep cycle; and responsive to the reduced functionality device waking from the sleep cycle, transmitting the held received messages to the reduced functionality device.

In another aspect, there is provided a device, including: a radio adapted for communicating within a mesh network; and a processor in communication with the radio, wherein in operation, the device is configured to: receive at least one transmission from at least one candidate router operating in the mesh network, the transmission including candidate router information; select a particular router from among the at least one candidate router; associate with an access point by sending a device identifier to the access point via the selected particular router; transmit a request for an access point service; initiate an energy conserving mode cycle; and retrieve a held message from the particular router after waking up from the energy conserving mode cycle, wherein the held message is received by the particular router during the device energy conserving mode cycle responsive to request of the access point service.

In another aspect, there is provided an advanced metering infrastructure system including: a mesh network; a plurality of routers at least intermittently coupled with the mesh network; a plurality of access points at least intermittently coupled with the mesh network; a plurality of wireless node devices adapted for communication with each other within the mesh network, each wireless node device including a radio adapted for wireless communicating within the mesh network, and a processor coupled for communication with the radio, the wireless node devices being configured for operation so that in operation each node device selects a particular router from the plurality of network routers, associates with a particular access point selected from the plurality of access points, enters an energy conserving operating state during which it is not able to receive any message from the network, and awakes from the energy conserving state to retrieve a message communicated on the network during the energy conserving state from the particular router.

In another aspect, there is provided a computer program stored in a computer readable form for execution in a processor and a processor coupled memory to implement a method for accessing access point services by a power-conserving network device, the method including: receiving at least one transmission from at least one candidate router, the transmission including candidate router information; selecting a particular router from the at least one candidate router; associating with an access point by transmitting a device identifier to the access point via the selected particular router; transmitting a request for an access point service; initiating an energy conserving cycle; and retrieving a held message from the particular router after automatically waking up from the energy conserving cycle, wherein the held message is received by the particular router during the energy conserving cycle responsive to the request for the access point service.

In another aspect, there is provided a computer program stored in a computer readable form for execution in a processor and a processor coupled memory to implement a method including: associating with a mesh network, the mesh network in communication with at least one mesh device; transmitting a router information to a reduced functionality device; receiving a device identifier from the reduced functionality device indicating a request for router services; forwarding communications from the reduced functionality device to a mesh device on the mesh network; responsive to receiving a message addressed to the reduced functionality device, holding the received message if the reduced functionality device is in a sleep cycle; and responsive to the reduced functionality device waking from the sleep cycle, transmitting the held received messages to the reduced functionality device.

In another aspect, there is provided a method for accessing access point services by a power-conserving network device via a particular router, including: associating with a mesh network by the particular router, the mesh network in communication with at least one mesh device; transmitting a router information from the particular router to the power-conserving network device; receiving at least one transmission at the power-conserving network device from at least one candidate router including the particular router, the transmission including candidate router information; selecting the particular router from the at least one candidate router at the power-conserving network device; receiving a device identifier at the particular router from the power-conserving network device indicating a request for router services; associating with an access point by transmitting a device identifier to the access point via the selected particular router; transmitting a request for an access point service from the power-conserving network device to the particular router; forwarding communications from the power-conserving network device to a mesh device on the mesh network by the particular router; initiating an energy conserving cycle by the power-conserving network device; responsive to receiving a message at the particular router addressed to the power-conserving network device, holding the received message if the power-conserving network device is in the energy conserving cycle; responsive to the power-conserving network device waking from the energy conserving cycle, transmitting the held received messages to the power-conserving network device from the particular router; and retrieving a held message from the particular router after automatically waking up from the energy conserving cycle, wherein the held message is received by the particular router during the energy conserving cycle responsive to the request for the access point service.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 illustrates an example system for providing communications in an Advanced Metering Infrastructure (AMI) system including a reduced functionality network device (RFND) also referred to as a power conserving network device (PCND).

FIG. 2 illustrates an example mesh device for use within a mesh network.

FIG. 3 illustrates an example network stack for use within a mesh radio.

FIG. 4A illustrates an example communication procedure for a RFND or PCND to communicate with a mesh network through a router and a mesh network associated with the router device.

FIG. 4B illustrates an example communication procedure for a router to service a RFND or PCND.

### DETAILED DESCRIPTION

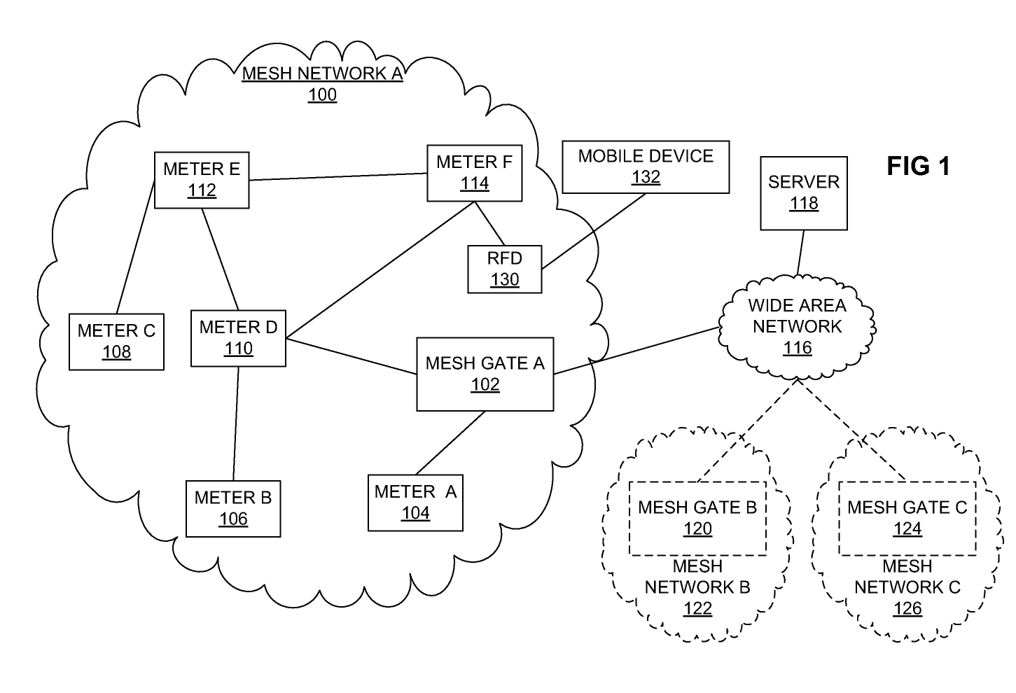

FIG. 1 illustrates an example system for providing communications in an Advanced Metering Infrastructure (AMI) system including a reduced functionality network device RFND. These reduced functionality network devices are also interchangeably referred to as power conserving network devices (PCND) and references to RFNDs will be synonymous with references to PCNDs. A mesh network A 100 may include an access point or device such as a mesh gate A 102 and a plurality of meters: meters A 104, B 106, C 108, D 110, E 112, and F 114. A mesh gate may also be referred to as a NAN-WAN gate or an access point.

An access point such as a Neighborhood Area Network to Wide Area Network (NAN-WAN) gate and also described as a mesh gate 102 in this and in related applications, may perform any one or more of many different functions including for example, but not limited to, one or any combination of: relaying information from a server (such as to a head end server) to the mesh network nodes, routing information, aggregating information from the nodes and microportals within any sub-network that may be configured for transmission to a server (such as to the head end server), acting as a HAN coordinator, acting as a NAN-WAN gate, transmitting firmware upgrades, and/or multicasting messages. A mesh gate may also be referred to as a collector because it collects information from the NAN-associated or other nodes and/or microportals in its sub-network.

The mesh gate A 102 may communicate with a server 118 over a wide area network (WAN) 116. Optionally, a mesh gate B 120 and a mesh network B 122 may also communicate with the server 118 over the WAN 116.

In one example embodiment, the server 118 is known as a “head end.” The mesh gate may also be known as a collector, a concentrator, or an access point.

It will be appreciated that a mesh device association can include a registration for application service at the mesh gate A 102 or the server 118. The mesh gate A 102 and the server 118 can maintain a table of available applications and services and requesting mesh devices.

Optionally, a mesh gate C 124 and a mesh network C 126 may also communicate with the server 118 over the WAN 116. A RFND 130 may communicate with a router within the mesh network. A mobile device 132 may communicate with mesh devices in the AMI system.

In the example of FIG. 1, the mesh network A 100 may include a plurality of mesh gates and mesh devices, such as meters which cover a geographical area. The meters may include utility sensors and be part of an AMI system and communicate with the mesh gates over the mesh network. For example, the AMI system may monitor utilities usage, such as gas, water, or electricity usage and usage patterns. Alternative mesh devices include thermostats, user displays, and other components for monitoring utilities.

In the example of FIG. 1, the mesh gate A 102 may provide a gateway between the mesh network and a server. The mesh gate A 102 may include a mesh radio to communicate with the mesh network and a WAN communication interface to communicate with a WAN.

In the example of FIG. 1, the mesh gate A 102 may aggregate information from meters within the mesh network and transmit the information to the server. In an alternative, incoming information from the meters may be forwarded when received. While only one mesh gate is depicted, any number of mesh gates may be deployed within the mesh network, for example, to improve transmission bandwidth to the server and provide redundancy in the mesh network. A typical system will include a plurality of mesh gates within the mesh network. In a non-limiting embodiment for an urban or metropolitan geographical area, there may be between 1 and 100 mesh gates. Other embodiments may provide for more mesh gates. In one embodiment, each mesh gate supports approximately 400 meters, depending on system requirements, wireless reception conditions, available bandwidth, and other considerations. It will be appreciated that it is sometimes advantageous to limit meter usage of bandwidth, such as during an initial configuration and deployment, such as to allow for future upgrades.

In the example of FIG. 1, the meters A 104, B 106, C 108, D 110, E 112, and F 114 may each be a mesh device associated with the mesh network through direct or indirect communications with the mesh gate. Each meter may forward transmissions from other meters within the mesh network towards the mesh gate. While only six meters are depicted, any number of meters may be deployed to cover any number of utility lines or locations within the mesh network.

In the example of FIG. 1, as depicted, meters A 104 and D 110 are in direct communications with mesh gate A 102. However, meters B 106, E 112 and F 114 can all reach mesh gate A 102 through meter D 110. Similarly, meter C 108 can reach mesh gate A 102 through meter E 112 and meter D 110.

In the example of FIG. 1, the WAN 116 may be a communication medium capable of transmitting digital information. For example, the WAN 116 may be the Internet, a cellular network, a private network, a phone line configured to carry a dial-up connection, an Ethernet network, or any other network, or a combination of any two or more such networks.

In the example of FIG. 1, the server 118 may be a computing device configured to receive information, such as meter readings, from a plurality of mesh networks and meters. The server 118 may also be configured to transmit instructions to the mesh networks, mesh gates, and meters.

In an alternative, any number of servers may be deployed in the AMI system. For example, servers may be distributed by geographical location for shorter communication distances and latency times. Redundant servers may provide backup and failover capabilities in the AMI system.

In the example of FIG. 1, the optional mesh gates B 120 and C 124 may be similar to mesh gate A 102, discussed above. Each mesh gate may be associated with a mesh network, similar to the mesh network A 100. For example, mesh gate B 120 may be associated with mesh network B 122 and mesh gate C 124 may be associated with mesh network C 126. Each mesh network may include a plurality of meters (not depicted). While only three mesh networks are depicted in FIG. 1, any number of mesh networks may exist in the AMI system.

In the example of FIG. 1, each mesh network may include meters covering a geographical area, such as, by way of example but not of limitation, a premise, a house, a residential building, a commercial building, a campus, an apartment building, or a residential block. Alternatively, the mesh network may include a utilities network and be configured to measure utilities flow at each sensor. Each mesh gate communicates with the server 118 over the WAN 116, and thus the server 118 may receive information from and control a large number of meters or mesh devices. Mesh devices may be located wherever they are needed, without the necessity of providing wired communications with the server.

In the example of FIG. 1, the RFND 130 may communicate with the server 118 via a router and the mesh gate. Communications may be facilitated by the meter over the mesh network to the mesh gate, and to the server 118 via the WAN 116. While only one RFND is depicted in FIG. 1, any number of RFNDs may exist in any of the mesh networks, or none.

The RFND 130 can be similar to ordinary mesh devices, such as meters A 104 to F 114. However, the RFND 130 cannot participate in the mesh device other than to utilize a router for communication. It is therefore unable to forward messages from one mesh device to a second mesh device or the mesh gate.

In the example of FIG. 1, the RFND 130 may associate with a router device, which can be a nearby mesh device or meter. For association, the RFND 130 may broadcast a neighbor request message to detect nearby mesh devices. Nearby mesh devices that receive the request and have router functionality may transmit a response. The response may include information such as a next hop towards the mesh gate, a number of hops to the mesh gate, a communication link quality indicator, a mesh gate load, and a router load. For example, a router load may be a remaining capacity of the router to service additional RFNDs. In an alternative, the RFND 130 may simply wait for a regularly scheduled neighbor information exchange between the meters of the mesh network. The neighbor information exchange may contain some or all of the above information.

In the example of FIG. 1, the RFND 130 may parse the responses received and select a router based on the response information. The RFND 130 may transmit an association request to the selected router. All future communications between the RFND 130 and the mesh network may occur through the router.

In the example of FIG. 1, the RFND 130 may be configured to initiate sleep cycles or other energy conservation cycles to conserve battery power. The sleep interval may be substantially predetermined or dynamically modified. For example, a default sleep cycle may be waking up ever 5 minutes or according to some other periodic or other time interval. However, if the RFND 130 transmits a message and expects a response, the sleep interval may be modified to a shorter period, for example, 10 seconds. In an alternative, the RFND 130 may be connected to a power line and thus not require a sleep cycle because energy conservation may not be required when there is continuous power source availability. In this alternative, the RFND 130 will function as a regular mesh device or meter, with no need to utilize a router to communicate with the mesh network.

In the example of FIG. 1, the RFND 130 may be a battery-operated or other storage cell device configured with a sleep cycle to conserve battery power. Because the RFND 130 will not always be on to receive messages, it must associate with a router with router functionality, for example, a neighboring mesh device, in order to associate with the mesh network. In one non-limiting embodiment the storage cell may be a capacitor. In another non-limiting embodiment the storage cell may be a battery.

In the example of FIG. 1, messages addressed to the RFND 130 would be instead transmitted to the associated router. The associated router will forward the message to the RFND 130 when the RFND 130 is awake. Similarly, the RFND 130 may transmit by first transmitting the message to the router, which then forwards the message to the mesh network and an intended recipient.

In the example of FIG. 1, the RFND 130 may associate and rebalance within the mesh network similar to a regular mesh device, but always operates through its router. If the router is lost, such as through router failure or loss of operating power, the RFND 130 may attempt to associate with an alternate router, similar to associating with the first router.

In the example of FIG. 1, the RFND 130 may include a manual or magnetic switch for waking the RFND 130. For example, service personnel may need to wake the RFND 130 to perform maintenance or repair work. By waking the RFND 130, the service personnel may communicate with it via, for example, a mobile device 132 discussed below.

In the example of FIG. 1, the mobile device 132 may be a mobile test device used by a user, for example, service personnel maintaining mesh devices and mesh networks within the AMI system. The mobile device 132 may be configured to broadcast a query for all nearby mesh devices, including RFNDs responsive to a user instruction. The query may include filtering criteria, such as limiting responding mesh devices to only gas meters, to only electric meters, on in any other way. Every qualifying mesh device that receives the query may reply with an identifier and a network address.

In the example of FIG. 1, in operation, an AMI system may facilitate communications between the system components. A mesh network A 100 may include a plurality of meters. The RFND 130 may be associated with the mesh network A 100 through a router, for example, meter F 114. The router may be selected by the RFND 130 from candidate routers with mesh radio range of the RFND 130.

The RFND 130 can also be known as an “end device” because it is always a leaf of the mesh network. A leaf in network parlance is a leaf or external node of the mesh network, and therefore has no children devices further from the mesh gate.

The RFND 130 may not usually support functionality to support child nodes within the mesh network. RFNDs 130 are less complex, have improved battery life, and are suitable for certain types of devices such as handheld displays. Utilizing RFNDs 130 within a mesh network also limits the number of mesh gates required.

In the example of FIG. 1, in operation, the mobile device 132 may communicate with the RFND 130 responsive to user instruction or action. For example, to maintain or troubleshoot the RFND 130 during a sleep cycle, the RFND 130 may be manually woken by pressing a button or activating a magnetic switch. Once awake, the RFND 130 may communicate with the mobile device 132 and respond to instructions.

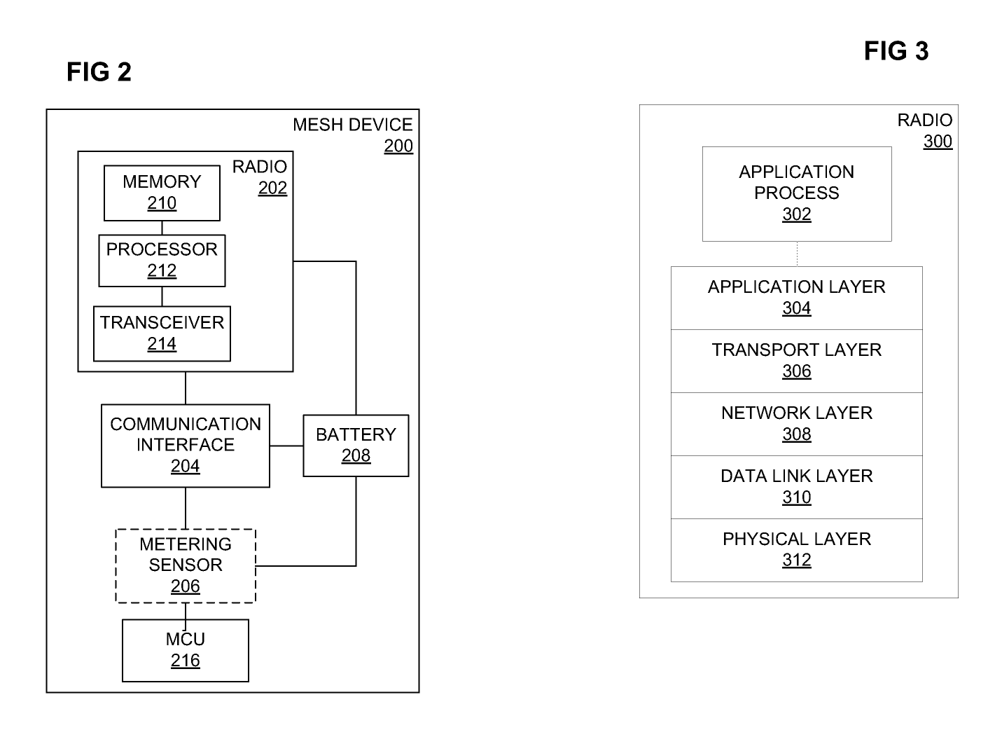

FIG. 2A illustrates an example mesh device for use within a mesh network. A mesh device 200 may include a radio 202, a communication card 204, a metering sensor 206, and a battery or other power or energy storage device or source 208. The radio 202 may include a memory 210, a processor 212, a transceiver 214, and a microcontroller unit (MCU) 216 or other processor or processing logic.

A mesh device can be any device configured to participate as a node within a mesh network. An example mesh device is a mesh repeater, which can be a wired device configured to retransmit received mesh transmissions. This extends a range of a mesh network and provides mesh network functionality to mesh devices that enter sleep cycles.

In another example, the mesh device 200 may be a RFND. The RFND can be a regular mesh device, but with additional energy conservation features, discussed above. In addition, the RFND is configured to communicate with a mesh network via a router.

In one embodiment, the RFND may be known as an end device, because it does not have any children within the mesh network and does not perform forwarding services. In another embodiment, the RFND may be known as a sleeping end device, because it enters sleep cycles to conserve power.

In the example of FIG. 2, the mesh device 200 may communicate with a mesh gate and other mesh devices over a mesh network. For example, the mesh device 200 may be a gas, water or electricity meter installed in a residential building or other location to monitor utilities usage. The mesh device 200 may also control access to utilities on server instructions, for example, by reducing or stopping the flow of gas, water or electricity. In an alternative, the mesh device 200 may be a mobile asset that needs to be tracked by the AMI system.

In the example of FIG. 2, the radio 202 may be a mesh radio configured to communicate with a mesh network. The radio 202 may transmit, receive, and forward messages to the mesh network. Any meter within the mesh network may thus communicate with any other meter or mesh gate by communicating with its neighbor and requesting a message be forwarded. The radio 202 may also communicate with an off-network device not associated with the mesh network.

In the example of FIG. 2, the communication card 204 may interface between the radio 202 and the sensor 206. Sensor readings or other data may be converted to radio signals for transmission over the radio. The communication card 204 may include encryption/decryption functionality or other security measures to protect the transmitted data. The communication card 204 may also decode instructions received from the server.

In the example of FIG. 2, the optional metering sensor 206 may be a gas, water, or electricity meter sensor, or another sensor. For example, digital flow sensors may be used to measure a quantity of water or gas flowing into a residence or building. Alternatively, the sensor 206 may be an electricity meter configured to measure a quantity of electricity flowing over a power line.

In the example of FIG. 2, the battery or other energy storage device 208 may be configured to independently power the meter during a power outage. For example, the battery 208 may be a large capacitor storing electricity to power the meter for at least five minutes after a power outage. Small compact but high capacity capacitors known as super capacitors are known in the art and may advantageously be used. One exemplary super capacitor is the SESSCAP 50 f 2.7v 18×30 mm capacitor manufactured by NESSCAP Co., Ltd. of Wonchun-Dong 29-9, Paldal-Ku, Soowon, Kyonggi-Do 442-380, Korea. Alternative battery or storage cell technologies may be used, for example, galvanic cells, electrolytic cells, fuel cells, flow cells, solar cells with storage, and voltaic cells.

In one alternative embodiment, the battery 208 may be the only source of power for the mesh device. Such a device may be a RFND configured for installation away from established power lines.

In the example of FIG. 2, the memory 210 may store instructions and run-time variables for execution. For example, the memory 210 may include both volatile and non-volatile memory. The memory 210 may also store a history of sensor readings from the metering sensor 206 and an incoming queue of server instructions.

In the example of FIG. 2, the processor 212 may execute instructions, for example, stored in the memory 210. Instructions stored in memory 210 may be ordinary instructions, for example, provided at the time of meter installation, or special instructions received from the server during run time.

In the example of FIG. 2, the transceiver 214 may transmit and receive wireless signals to a mesh network. The transceiver 214 may be configured to transmit sensor readings and status updates under control of the processor 212. The transceiver 214 may receive server instructions from a server, which are communicated to the memory 210 and the processor 212.

In the example of FIG. 2, the MCU 216 can execute firmware or software required by the mesh device 200. The firmware or software can be installed at manufacture or via a mesh network over the radio 202.

In one embodiment, any number of MCUs can exist in the mesh device 200. For example, two MCUs can be installed, a first MCU for executing firmware handling communication protocols, and a second MCU for handling applications.

In the example of FIG. 2, each component may be modular and configured for easy removal and replacement. This facilitates component upgrading over a lifetime of the meter as new functionality are developed and deployed in the AMI system.

In the example of FIG. 2, meters may be located in geographically dispersed locations within an AMI system. For example, a meter may be located near a gas line, an electric line, or a water line entering a building or premise to monitor a quantity of gas, electricity, or water flowing through the line. The meter may communicate with other meters and mesh gates through a mesh network. The meter may transmit meter readings and receive instructions via the mesh network.

In the example of FIG. 2, in operation, the mesh device 200 may communicate over a mesh network and directly with an off-network device via the radio 202. The communication card 204 may interface between the metering sensor 206 and the radio 202. For example, sensor readings may be transmitted to and instructions received from a server.

In an alternative, mesh devices may be similar to meters except the metering sensor is replaced by components necessary to perform the mesh device's function. For example, a user display may include an output screen. For another example, a thermostat may include a dial for receiving user input and an analog/digital converter to produce an input signal.

In an alternative, the mesh device 200 may be a RFND (or PCND) configured to enter regular sleep cycles to conserve battery power. Such a mesh device may be configured to associate with a mesh network and communicate with a mesh gate and server through a nearby router.

It will be appreciated that a mesh device 200 and a mesh gate can share the same architecture. The radio 202 and the MCU 216 provide the necessary hardware and the MCU 216 executes any necessary firmware or software.

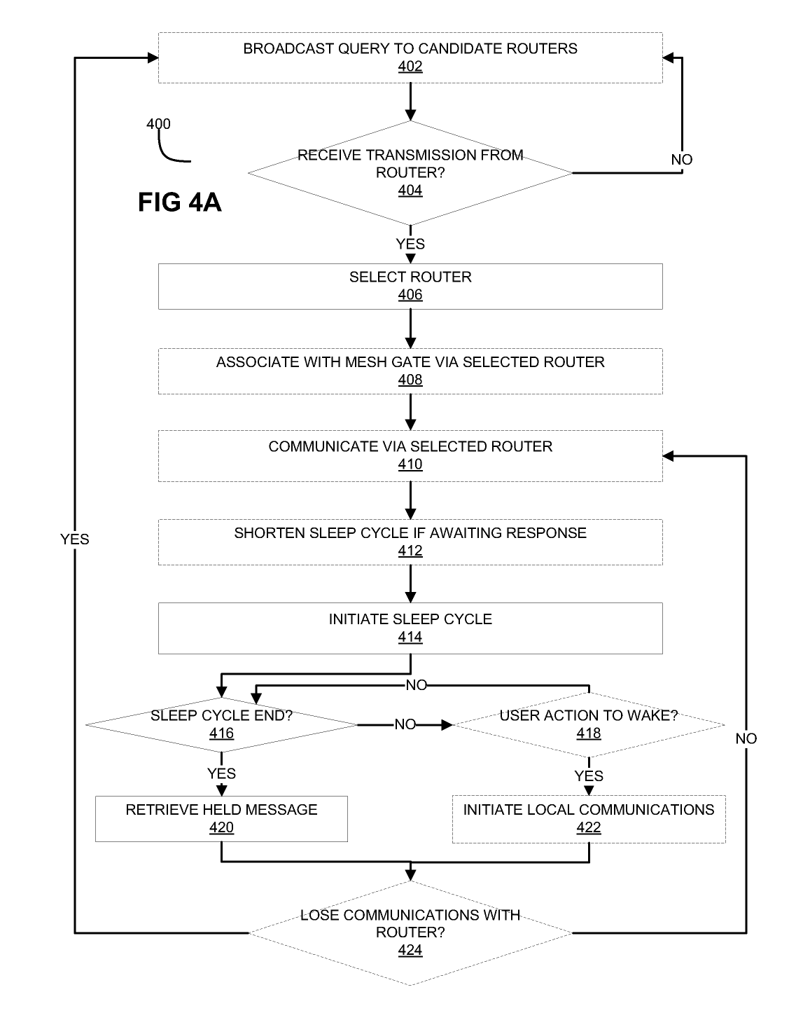

FIG. 3 illustrates an example network stack for use within a mesh radio 300. In the standard Open Systems Interconnection Basic Reference Model network protocol design, there are known to be seven layers, including the Application layer, Presentation layer, Session layer, Transport layer, Network layer, Data Link layer, and Physical layer. Although the innovations described herein are not constrained to any particular model or layers, it may be convenient to think about the innovations in terms of these models. For example, the application process 302 may communicate with an application layer 304, a transport layer 306, a network layer 308, a data link layer 310, and a physical layer 312.

In the example of FIG. 3, the radio 300 may be a mesh radio installed in a mesh gate, a mesh device or an off-network device. For example, the radio 300 may be a component in a meter, a mesh gate, or any other mesh device configured to participate in a mesh network or communicate with other mesh devices. The radio 300 may be configured to transmit wireless signals over a predetermined or dynamically determined frequency to other radios.

In the example of FIG. 3, the application process 302 may be an executing application that requires information to be communicated over the network stack. For example, the application process 302 may be software or firmware or a combination of the two supporting an AMI system, such as software and/or firmware executing on an electricity meter or a mesh gate.

In the example of FIG. 3, the application layer 304 interfaces directly with and performs common application services for application processes. Functionality includes semantic conversion between associated application processes. For example, the application layer may be implemented as ANSI C12.12/22 or according to other standards.

In the example of FIG. 3, the transport layer 306 responds to service requests from the application layer 304 and issues service requests to the Internet layer 308. It delivers data to the appropriate application on the host computers. For example, the layer 306 may be implemented as TCP (Transmission Control Protocol), and UDP (User Datagram Protocol).

In the example of FIG. 3, the network layer 308 is responsible for end-to-end (source-to-destination) packet delivery. The network layer's functionality includes transferring variable length data sequences from a source to a destination via one or more networks while maintaining the quality of service, and error control functions. Data will be transmitted from its source to its destination, even if the transmission path involves multiple hops. For example, the network layer 308 may translate a short address into a network address.

In the example of FIG. 3, the data link layer 310 transfers data between adjacent network nodes in a network, wherein the data is in the form of packets. The layer 310 provides functionality including transferring data between network entities and error correction/detection. For example, the layer 310 may be implemented as IEEE 802.15.4 or according to other standards.

In the example of FIG. 3, the physical layer 312 may be the most basic network layer, transmitting bits over a data link connecting network nodes. No packet headers or trailers are included. The bit stream may be grouped into code words or symbols and converted to a physical signal, which is transmitted over a transmission medium, such as radio waves. The physical layer 312 provides an electrical, mechanical, and procedural interface to the transmission medium. For example, the layer 312 may be implemented as IEEE 802.15.4 or according to other standards.

In the example of FIG. 3, in operation, the network stack provides different levels of abstraction for programmers within an AMI system. Abstraction reduces a concept to only information which is relevant for a particular purpose. Thus, each level of the network stack may assume the functionality below it on the stack is implemented. This facilitates programming features and functionality for the AMI system. The illustrated network stack may facilitate intra-mesh network communication by utilizing a short address to identify addressees.

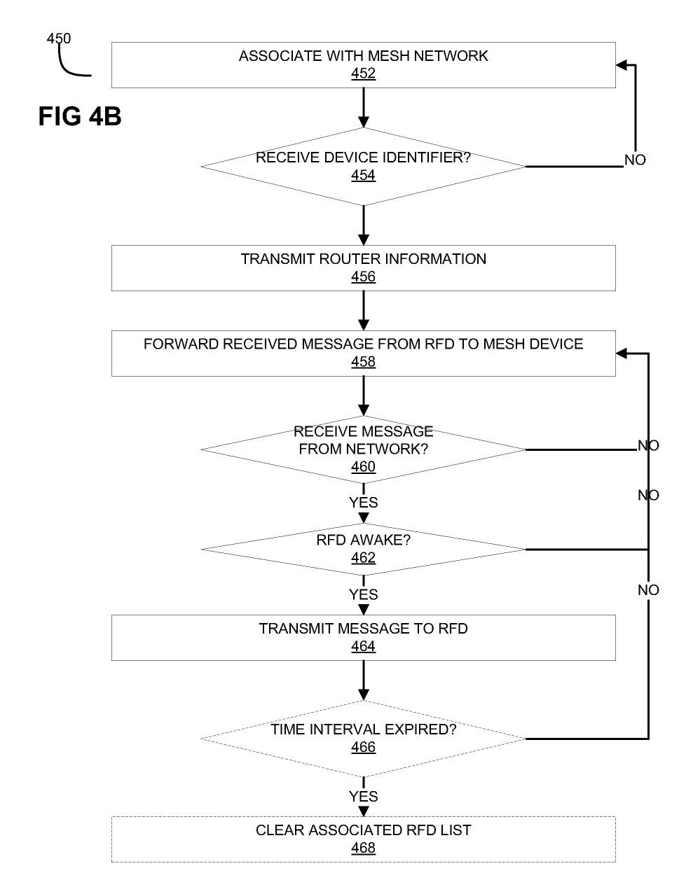

FIG. 4A illustrates an example communication procedure 400 for a RFND to communicate with a mesh network through a router and a mesh network associated with the router device. The procedure may execute on a RFND that seeks a nearby router with which to associate. Because the RFND enters periodic sleep cycles, it requires a router to participate in the mesh network, for example, by holding response messages until the RFND is awake.

In the example of FIG. 4A, in step or process 402, the RFND may optionally broadcast a query to candidate routers. For example, the broadcasted query may include a RFND identifier and a request for router information from nearby candidate routers. The query may be broadcast on a predetermined channel or frequency that is monitored by candidate routers.

In an alternative, the RFND may not broadcast the query, and simply wait for router information to be transmitted on a regular or other interval within the mesh network. Thus, the RFND may simply listen on a predetermined channel or frequency for the regular transmission of router information. For example, router information may be transmitted as part of a neighbor information exchange.

In the example of FIG. 4A, in step or process 404, the RFND may test whether a transmission has been received from at least one candidate router. For example, the transmission may include a router information and be received responsive to a broadcasted query. In an alternative, the transmission may be received as part of a regularly scheduled transmission within the mesh network. The RFND may wait for a predetermined or dynamically determined interval to receive one or more transmissions from nearby candidate routers. The router information may include, for example, a number of hops between the router and the mesh gate, a mesh gate load, a path signal quality, and a router load.

In the example of FIG. 4A, if at least one transmission has been received, the RFND may proceed to step or process 406. If no transmissions have been received, the RFND may wait for a time out period for at least one transmission, conclude that no nearby candidate routers are available and notify a user, or proceed to step or process 402 where the query is re-broadcast.

In the example of FIG. 4A, in step or process 406, the RFND may select a router from the at least one candidate routers from where transmissions were received above. For example, a router score may be calculated from each received transmission including a router information. The candidate router with the best score may be selected. The router score may be calculated from a predetermined or dynamically determined formula including some or all information of the router information.

In one alternative, there may be a minimum acceptable router score required before the candidate router is selected. If no router score from any candidate router exceeds the minimum required router score, no router may be selected.

In the example of FIG. 4A, in step or process 408, the RFND may optionally associate with a mesh gate via the selected router. For example, the RFND may transmit an association request to the selected router. The selected router may add the RFND to an associated RFND table.

If the RFND is already associated with a mesh gate via the selected router, this RFND proceeds to step or process 410.

In the example of FIG. 4A, the selected router may be unable to accept the association request. In this example, an error or rejection response may be received at the RFND. The RFND may return to step or process 406 and select another router for association.

In the example of FIG. 4A, in step or process 410, the RFND may optionally communicate with mesh devices or a server via the selected router. For example, the RFND may transmit a message to one or more recipient. Messages to be transmitted may first be transmitted to the selected router before being forwarded to the mesh network for deliver.

In an alternative, the RFND may not store the recipient address due to limited memory. In this non-limiting example, the RFND may transmit the message to the selected router along with a description of the intended recipient, for example, the local mesh gate or the server. The selected router may insert the correct recipient address before forwarding the message to the mesh network.

In addition, the RFND may periodically transmit a “keep alive” message to the mesh gate via the selected router. This informs the mesh gate the RFND is still active.

In the example of FIG. 4A, in step or process 412, the RFND may optionally shorten a sleep cycle if awaiting a response from a transmitted message. For example, if a message was sent for forwarding by the selected router, a response may be expected. The sleep cycle may ordinarily be 5 minutes (or some other sleep cycle time interval), but is shortened to 10 seconds (or some other shorted time interval) if a response is expected.

In the example of FIG. 4A, in step or process 414, the RFND may initiate a sleep cycle to conserve battery power. Any sleep cycle duration may be selected, and considerations may include maximizing battery life and improving RFND responsiveness in the AMI system. For example, a count-down counter may be initiated, which will trigger a wake up routine in the RFND at the end of the sleep cycle.

In the example of FIG. 4A, in step or process 416, the RFND may test whether the sleep cycle has ended. If a wake up routine has been activated, the RFND may power up and perform any necessary maintenance as well as receive any held messages from the selected router.

In the example of FIG. 4A, the RFND may proceed to step 420 if the sleep cycle ended normally. Otherwise, the RFND may still be asleep and proceed to step or process 416.

In the example of FIG. 4A, in step or process 418, the RFND may optionally test whether a user action requesting the RFND wake up has been detected. For example, users may be service personnel authorized to maintain and repair the RFND. As the RFND spends a large portion of time in sleep mode, it may be necessary to provide a method of manually waking the RFND for maintenance or repair work. For example, the RFND may be equipped with a magnetic switch which is activated when the user brings a magnet in proximity to the RFND. In an alternative, the RFND may include a mechanical device, such as a switch on an outside surface accessible to the user for such purpose.

In the example of FIG. 4A, the RFND may proceed to step 422 if the user has initiated a manual wake up routine. If not, the RFND may remain asleep and proceed to step or process 416.

In the example of FIG. 4A, in step or process 420, the RFND retrieves held messages from the router. The RFND may transmit a request to the selected router for any held messages to be transmitted. In an alternative, the RFND may transmit a sleep interval before each sleep cycle to the selected router. In this example, the selected router will transmit any held messages when it knows the RFND is awake. If no held messages are stored at the selected router, an “all-clear” message may be received.

In the example of FIG. 4A, the RFND may also transmit any necessary messages when awake. Messages may be transmitted to the selected router for forwarding.

In the example of FIG. 4A, in step or process 422, the RFND may optionally initiate local communications with an off-network device. The off-network device may not be associated with the mesh network, and thus unable to communicate with the RFND through the mesh network. However, local communications are still possible through direct radio contact with the off-network device.

In an alternative, any other type of communication may occur after the RFND is awake. For example, the service personnel may interact with the mesh gate of the mesh network after waking up the RFND. The mesh gate may interface between the user and the RFND.

In the example of FIG. 4A, in step or process 424, the RFND may test whether communications have been lost with the router. For example, if no messages are received from the selected router over a timeout interval, the RFND may assume the selected router has failed or is otherwise unable to provide router services. If communications are lost, the RFND may proceed to step or process 402 where a new router is selected. If communications are still occurring, the router may proceed to step or process 410 where further communications may occur.

In the example of FIG. 4A, in operation, the RFND selects a router through which communications with a mesh network are conducted. Through the mesh network, the RFND may communicate with other mesh devices and a mesh gate. Through the mesh gate, the RFND may communicate with a server. The router may hold messages addressed to the RFND when the RFND is in a sleep cycle for delivery when the RFND is awake.

FIG. 4B illustrates an example communication procedure 450 for a router to service a RFND. The procedure may execute on a router within a mesh network. For example, the router may be a mesh device with routing functionality, configured to associate with RFNDs and providing routing services. The router may be in communication with a mesh gate over the mesh network, and the mesh gate may be in communication with a server over a WAN. The router may perform routing functionality in addition to ordinary mesh device functionality. For example, the router may also be a meter, a user interface, a thermostat, or any other mesh device in the AMI system.

In the example of FIG. 4B, in step or process 452, the router may associate with a mesh network. For example, the router may be a mesh device within the mesh network, and associate with the mesh network at power up or detection of the mesh network. If more than one mesh network are within radio range of the router, the router may select a most suitable mesh network for association. Once associated with the mesh network, the router may communicate with other mesh devices on the mesh network, including meters and mesh gates. Further, the router may communicate with a server via the mesh gate.

In the example of FIG. 4B, in step or process 454, the router may test whether a RFND identifier is received. The RFND identifier can be received along with a request for association.

In an alternative embodiment, the RFND may simply transmit a request for association. The identifier may uniquely identify the RFND and be programmed at manufacture.

If an identifier has been received, the router may proceed to step or process 456. If no identifier has been received, the router may return to step or process 452 and assume no nearby RFND requires routing services.

In the example of FIG. 4B, in step or process 456, the router may transmit router information. For example, the router information may include a number of hops between the router and the mesh gate, a mesh gate load, a path signal quality, and a router load. In one example, the router information may be transmitted in response to a query broadcasted from a RFND. In an alternative, the router information may be transmitted as part of a regularly scheduled neighbor exchange between mesh devices on the mesh network. For example, a neighbor exchange may allow mesh devices to exchange neighbor information amongst each other and include router information.

In the example of FIG. 4B, in step or process 458, the router may forward a message received from the RFND. The received message can be forwarded to other mesh devices or the server. For example, the router may receive messages for transmission from the RFND and forward the messages over the mesh network. If the RFND does not have the address of the intended recipient, the router may supply the correct address. Other routing services may also be provided.

If no communications need forwarding from the RFND, no routing functionality is provided. In addition to routing functionality, the router may also perform other mesh device function, as discussed above.

In the example of FIG. 4B, in step or process 460, the router may receive a message from the mesh network for forwarding to the RFND. For example, the message may be received responsive to a message forwarded to the mesh network by the router. For another example, the message may be a response to a message transmitted by the RFND.

In an alternative, the sleep cycle duration of the RFND may be shortened if a message is expected, for example, in response to a transmitted request. If a message is received for the RFND, the router may proceed to step or process 462. If no message is received for the RFND, the router may proceed to step or process 458 and continue providing routing functions.

In the example of FIG. 4B, in step or process 462, the router may test whether the RFND is awake. For example, the RFND may transmit a status update every time it is awake, which will indicate a wake state to the router.

In an alternative, the RFND may transmit a sleep cycle duration to the router before every sleep cycle. In this way, the router will know when the RFND will wake from its current sleep cycle. If the RFND is awake, the router may proceed to step or process 464. If the RFND is asleep, the router may proceed to step or process 458.

In the example of FIG. 4B, in step or process 464, the router may transmit any held messages as well as status updates to the RFND. Held messages may be messages transmitted to the RFND from other mesh devices or from the server, but which were held by the router because the RFND was asleep and unable to receive any messages.

In the example of FIG. 4B, in step or process 466, the router may optionally check whether a time interval has expired. For example, the router may be programmed to check whether the RFND has been awake and in communication within the past 24 hours. If the RFND has not been in communication for a long period of time, the router may assume the RFND has become non-functional or non-communicative. If the time interval has expired, the router may proceed to step or process 468. If the time interval has not expired, the router may proceed to step or process 458.

In the example of FIG. 4B, in step or process 468, the router may optionally clear a list of associated RFNDs. For example, if the RFND has not been in communication with the router, the router may remove it from a list of RFNDs being serviced. This may conserve the router's resources for RFNDs that are active and actually require routing services.

In an alternative, the router may only service a predetermined number of RFNDs at a time. Thus, it is important to clear out RFNDs that no longer require routing services, so other RFNDs may be serviced.

In an alternative, step or process 452, 454 and 456 can be executed in a single process. Similarly, step or process 458 and 460 can be executed in a second process. Similarly, step or process 462, 464, 466, and 468 can be executed in a third process. The three processes can execute in parallel, improving the functionality provided by the router.

Although the above embodiments have been discussed with reference to specific example embodiments, it will be evident that the various modification, combinations and changes can be made to these embodiments. Accordingly, the specification and drawings are to be regarded in an illustrative sense rather than in a restrictive sense. The foregoing specification provides a description with reference to specific exemplary embodiments. It will be evident that various modifications may be made thereto without departing from the broader spirit and scope as set forth in the following claims. The specification and drawings are, accordingly, to be regarded in an illustrative sense rather than a restrictive sense.

What is claimed is:

1. A method for accessing access point services by a device, comprising:
receiving at least one transmission from at least one candidate router, the transmission including candidate router information;
selecting a particular router from the at least one candidate router;
associating with an access point by transmitting a device identifier to the access point via the selected particular router;
transmitting a request for an access point service;
initiating an energy conserving cycle; and
retrieving a held message from the particular router after automatically waking up from the energy conserving cycle, wherein the held message is received by the particular router during the energy conserving cycle responsive to the request for the access point service.

2. The method of claim 1, wherein the device is a power-conserving network device and the energy conserving cycle is a sleep cycle.

3. The method of claim 1, wherein the access point comprises at least one of: a NAN-WAN gate and a mesh gate.

4. The method of claim 1, wherein the energy conserving cycle comprises a processor sleep cycle wherein a processor enters a reduced power consumption mode for a predetermined period of time before waking up.

5. The method of claim 4, further comprising:
predetermined period of time before waking up if awaiting a held message responsive to the request for the access point service.

6. The method of claim 1, wherein the energy conserving cycle comprises a device sleep cycle wherein the power-conserving network device enters a reduced power consumption mode for a predetermined period of time before waking up.

7. The method of claim 1, wherein the at least one candidate router comprises a plurality of candidate routers.

8. The method of claim 7, wherein the plurality of candidate routers comprises at between 2 and 20 candidate routers.

9. The method of claim 1, further comprising:
broadcasting a query to nearby candidate routers, wherein the at least one transmission is received responsive to the broadcasted query.

10. The method of claim 1, wherein the access point service is communication with at least one of: a mesh device and a server.

11. The method of claim 10, wherein the held message is a command from a server.

12. The method of claim 1, wherein the particular router is selected in part based on a router score, wherein the router score is calculated from a number of hops between the router and the access point, an access point load, a path signal quality, and a router load.

13. The method of claim 1, further comprising:
responsive to losing communications with the router, selecting a replacement router.

14. The method of claim 1, further comprising:
responsive to a user action, waking from the energy conserving cycle and initiating local communications with an off-network device.

15. The method of claim 14, wherein the user action is activating a mechanical switch.

16. A method, comprising:
associating with a mesh network, the mesh network in communication with at least one mesh device;
transmitting a router information to a reduced functionality device;
receiving a device identifier from the reduced functionality device indicating a request for router services;
forwarding communications from the reduced functionality device to a mesh device on the mesh network;
responsive to receiving a message addressed to the reduced functionality device, holding the received message if the reduced functionality device is in a sleep cycle; and
responsive to the reduced functionality device waking from the sleep cycle, transmitting the held received messages to the reduced functionality device.

17. The method of claim 16, wherein the received message is from at least one of: a server, a mesh gate, and a mesh device.

18. The method of claim 16, wherein the received message is received responsive to a previous forwarded communication from the reduced functionality device.

19. The method of claim 16, wherein the router information includes at least one of: a number of hops between the router and the mesh gate, a mesh gate load, a path signal quality, and a router load.

20. The method of claim 16, wherein the router information is transmitted responsive to a reduced functionality device broadcasted query.

21. The method of claim 16, further comprising:
periodically clearing a list of associated reduced functionality device.

22. A device, comprising:
a radio adapted for communicating within a mesh network; and
a processor in communication with the radio, wherein in operation, the device is configured to:
receive at least one transmission from at least one candidate router operating in the mesh network, the transmission including candidate router information;
select a particular router from among the at least one candidate router;
associate with an access point by sending a device identifier to the access point via the selected particular router;
transmit a request for an access point service;
initiate an energy conserving mode cycle; and
retrieve a held message from the particular router after waking up from the energy conserving mode cycle, wherein the held message is received by the particular router during the device energy conserving mode cycle responsive to request of the access point service.

23. The device of claim 22, the device further configured to
broadcast a query, wherein the at least one transmission is received responsive to the broadcasted query.

24. The device of claim 22, wherein the selected router is selected in part based on a router score, wherein the router score is calculated from a number of transmission relay hops between the router and the access point, an access point load, a path signal quality, a router load, and any combination of two or more of these.

25. The device of claim 22 further comprising:
an energy storage device, the energy storage device configured to power the device.

26. The device of claim 25, wherein the energy storage device comprises a battery.

27. The device of claim 25, wherein the energy storage device comprises a capacitor.

28. An advanced metering infrastructure system comprising:
a mesh network;
a plurality of routers at least intermittently coupled with the mesh network;
a plurality of access points at least intermittently coupled with the mesh network;
a plurality of wireless node devices adapted for communication with each other within the mesh network, each wireless node device including:
a radio adapted for wireless communicating within the mesh network; and
a processor coupled for communication with the radio;
the wireless node devices being configured for operation so that in operation each node device selects a particular router from the plurality of network routers, associates with a particular access point selected from the plurality of access points, enters an energy conserving operating state during which it is not able to receive any message from the network, and awakes from the energy conserving state to retrieve a message communicated on the network during the energy conserving state from the particular router.

29. A computer program stored in a computer readable form for execution in a processor and a processor coupled memory to implement a method for accessing access point services by a power-conserving network device, the method comprising:
receiving at least one transmission from at least one candidate router, the transmission including candidate router information;
selecting a particular router from the at least one candidate router;
associating with an access point by transmitting a device identifier to the access point via the selected particular router;
transmitting a request for an access point service;
initiating an energy conserving cycle; and
retrieving a held message from the particular router after automatically waking up from the energy conserving cycle, wherein the held message is received by the particular router during the energy conserving cycle responsive to the request for the access point service.

30. A computer program stored in a computer readable form for execution in a processor and a processor coupled memory to implement a method comprising:
associating with a mesh network, the mesh network in communication with at least one mesh device;
transmitting a router information to a reduced functionality device;
receiving a device identifier from the reduced functionality device indicating a request for router services;
forwarding communications from the reduced functionality device to a mesh device on the mesh network;
responsive to receiving a message addressed to the reduced functionality device, holding the received message if the reduced functionality device is in a sleep cycle; and
responsive to the reduced functionality device waking from the sleep cycle, transmitting the held received messages to the reduced functionality device.

31. A method for accessing access point services by a power-conserving network device via a particular router, comprising:
associating with a mesh network by the particular router, the mesh network in communication with at least one mesh device;
transmitting a router information from the particular router to the power-conserving network device;
receiving at least one transmission at the power-conserving network device from at least one candidate router including the particular router, the transmission including candidate router information;
selecting the particular router from the at least one candidate router at the power-conserving network device;
receiving a device identifier at the particular router from the power-conserving network device indicating a request for router services;
associating with an access point by transmitting a device identifier to the access point via the selected particular router;
transmitting a request for an access point service from the power-conserving network device to the particular router;
forwarding communications from the power-conserving network device to a mesh device on the mesh network by the particular router;
initiating an energy conserving cycle by the power-conserving network device;
responsive to receiving a message at the particular router addressed to the power-conserving network device, holding the received message if the power-conserving network device is in the energy conserving cycle;
responsive to the power-conserving network device waking from the energy conserving cycle, transmitting the held received messages to the power-conserving network device from the particular router; and
retrieving a held message from the particular router after automatically waking up from the energy conserving cycle, wherein the held message is received by the particular router during the energy conserving cycle responsive to the request for the access point service.
